(19) United States
(12) Patent Application Publication
(10) Pub. No.: US 2010/0079819 A1
(43) Pub. Date: Apr. 1, 2010

(54) PRINTER AND PRINT METHOD

(75) Inventor: Tetsuya Ouchi, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/568,731

(22) Filed: Sep. 29, 2009

(30) Foreign Application Priority Data
Sep. 29, 2008 (JP) 2008-251848

(51) Int. Cl. H04N 1/407

(52) U.S. Cl. 358/3.26

(57) ABSTRACT

A printer includes a print unit which prints an image on a recording medium by adhering recording material based on image data; a storage unit which stores a value corresponding to a reference recording material density; a reference density acquisition unit which acquires from the image data a reference recording material density of an area within the image; a specifying unit which specifies a value corresponding to the acquired reference recording material density by referring to the storage unit; a detection unit which detects a recording material density in the area of the printed image; a determination unit which determines whether the detected recording material density in the area is within a range determined based on the specified value; and a controller which indicates a print failure and/or stops printing if the determination unit determines that the detected recording material density detected is outside of the range.

### CROSS-REFERENCE TO RELATED APPLICATION

This application claims priority from Japanese Patent Application No. 2008-251848, filed on Sep. 29, 2008, the entire subject matter of which is incorporated herein by reference.

### TECHNICAL FIELD

Aspects of the present invention relate to a printer and a print method.

### BACKGROUND

A printer which prints an image on a recording medium in accordance with image data by adhering recording material on the recording medium has been known. Such a printer is equipped with a recording material empty detection mechanism of a mark print type, which prints a mark on a recording medium, to thus determine a recording material empty.

For example, at printer detects the reflection density of a mark recorded on a recording sheet and the reflection density of a blank area of the recording sheet by means of a photoelectric sensor, to thus determine a difference between the reflection densities of the mark and the blank area, so that the influence of variations in the sensitivity of the photoelectric sensor can be reduced. Accordingly, the printer can more accurately determine recording material empty when compared with a case where the presence or absence of a mark is simply detected.

However, the above-described printer has to print a mark for detecting recording material empty on a recording sheet. Additionally, although the mark is useful in detecting recoding material empty, the mark recorded on the recording sheet is unsightly and might cause an impression of wasteful material consumption.

### SUMMARY

Exemplary embodiments of the present invention address the above disadvantages and other disadvantages not described above. However, the present invention is not required to overcome the disadvantages described above, and thus, an exemplary embodiment of the present invention may not overcome any of the problems described above.

Accordingly, it is an aspect of the present invention to provide a printer which can detect occurrence of an ejection failure without printing a detection mark on a recording medium.

According to an exemplary embodiment of the present invention provides a printer comprising: a print unit which prints an image on a recording medium by adhering recording material thereonto based on image data; a storage unit which stores a value corresponding to a reference recording material density; a reference density acquisition unit which acquires from the image data a reference recording material density of an area within the image; a specifying unit which specifies a value corresponding to the reference recording material density acquired by the reference density acquisition unit by referring to the storage unit; a detection unit which detects a recording material density in the area of the image printed on the recording medium by the print unit; a determination unit which determines whether the recording material density in the area detected by the detection unit is within a range determined based on the value specified by the specifying unit; and a controller which indicates a print failure and/or stops printing if the determination unit determines that the recording material density detected by the detection unit is outside of the range.

According to another exemplary embodiment of the present invention, there is provided a print method for a printer including a print unit which prints an image of a recording medium by adhering recording material thereonto based on image data, and a storage unit which stores values corresponding to a plurality of reference recording material densities. The print method comprises: extracting an area in which an image is printed by the print unit with any one of the plurality of reference recording material densities, from the image data, and acquiring a reference recording material density of the extracted area; specifying a value corresponding to the acquired reference recording material density by referring to the storage unit; detecting a recording material density in the area of the image printed on the recording medium; determining whether the detected recording material density in the area is within a range based on the specified value; and indicating a print failure and/or stopping printing if it is determined that the detected recording material density is outside of the range.

### BRIEF DESCRIPTION OF THE DRAWINGS

The above and other aspects of the present invention will become more apparent and more readily appreciated from the following description of exemplary embodiments of the present invention taken in conjunction with the attached drawings, in which:

FIG. 1 is an external perspective view of an MFP which is an example of a printer according to an exemplary embodiment of the present invention;

FIG. 2A is a block diagram showing an electrical configuration of the MFP;

FIG. 2B is a schematic view showing example specifics of an ejection failure threshold table;

FIG. 3A is a schematic view showing an example relationship among ink density, the amount of received light, and an ejection failure threshold;

FIG. 3B is a schematic view showing example specifics of a received-light-amount measurement position table;

FIG. 4 is a flowchart showing print processing of the MFP;

FIG. 5 is a flowchart showing color measurement position extraction processing of the MFP;

FIG. 6 is a conceptual view showing an example recording sheet printed with an image on the first page; and

FIG. 7 is a conceptual view showing an example recording sheet printed with an image on the second page.

### DETAILED DESCRIPTION

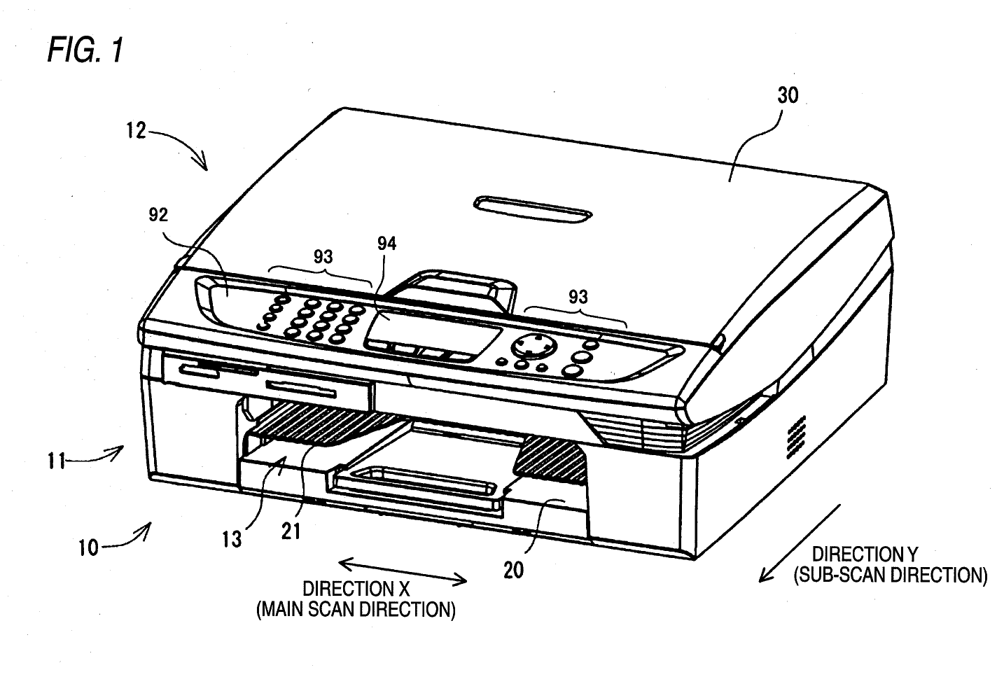

Exemplary embodiments of the present invention will be described below with reference to drawings. A multifunction peripheral (MFP) 10 shown in FIG. 1 is an example of a printer according to an exemplary embodiment of the present invention. The MFP 10 has various functions, such as a printer function, a scanner function, and a copier function.

The MFP 10 is configured to detect occurrence of a failure in ink ejection, from an image actually printed on a recording sheet (a recording medium) without printing a detection mark, such as a registration mark or a trim mark.

The MFP 10 includes a printer 11 provided in a lower area, a scanner 12 provided in an upper area, and an operation panel 92 provided on an upper front area. An opening 13 is provided in the front of the printer 11, and a sheet-feeding tray 20 and a sheet discharge tray 21 are stacked one on top of the other in two layers so as to be partially exposed through the opening 13. The sheet-feeding tray 20 is for accommodating recording sheets. One of the recording sheets accommodated in the sheet-feeding tray 20 is fed to the interior of the printer 11 and discharged to the sheet discharge tray 21 after having been printed with a desired image.

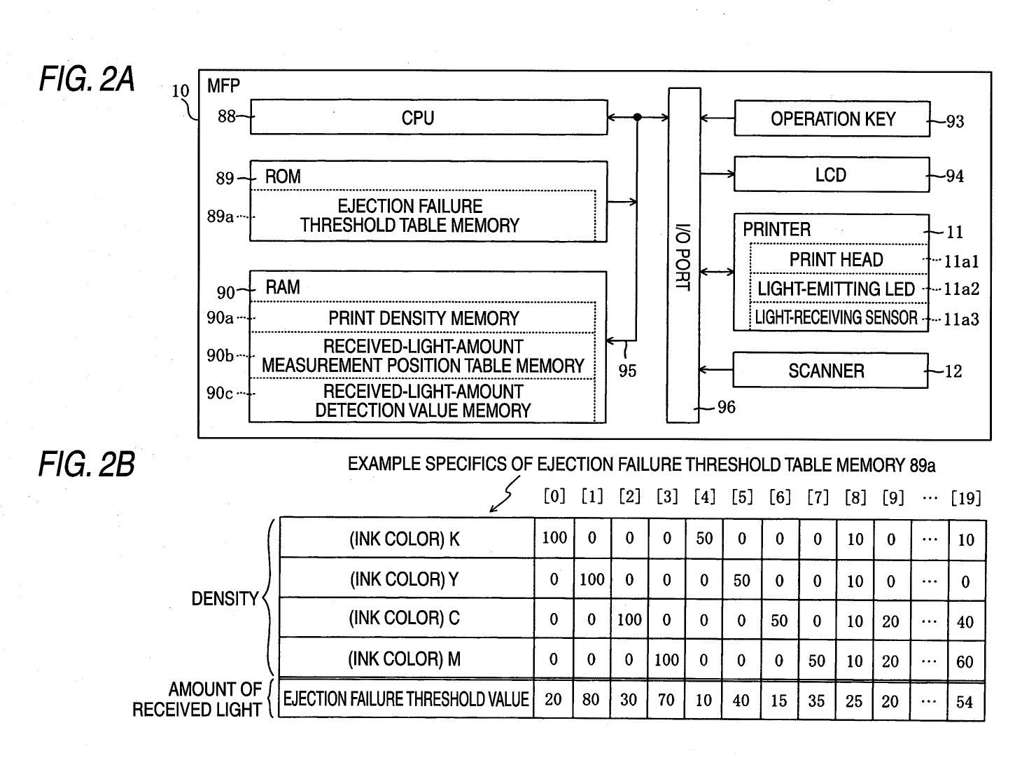

The printer 11 is configured as an inkjet printer and performs color printing by use of four colors of ink, Cyan (C) ink, Magenta (M) ink, Yellow (Y) ink, and Black (K) ink. The printer 11 includes a recording sheet conveyance motor (not shown) which conveys a recording sheet; a print head 11a1 (see FIG. 2A) which ejects ink to a recording sheet; a light-emitting LED 11a2 (see FIG. 2A) which emits light to the recording sheet; a light-receiving sensor 11a3 (see FIG. 2A) which detects the amount of light reflected from the recording sheet (the amount of received light) among the light emitted to the recording sheet; a carriage (not shown) carrying the print head 11a1, the light-emitting LED 11a2, and the light-receiving sensor 11a3; and a carriage motor (not shown) which reciprocally moves the carriage in a main scan direction (along a direction X in FIG. 1).

When an image is printed on a recording sheet, the recording sheet is first fed from the sheet-feeding tray 20. The thus-fed recording sheet is conveyed into the opening 13 and is guided so as to make a U-turn from down to up, thereby reaching a carriage. The recording sheet is conveyed in a sub-scan direction (a direction Y in FIG. 1) orthogonal to the main scan direction up to a position where printing of an image starts, and the carriage is moved in the main scan direction X up to the position where printing of the image starts. Subsequently, the carriage is moved in the main scan direction while ink is ejected from the print head 11a1 of the carriage, whereupon one line of an image is printed on the recording sheet in the main scan direction.

After completion of printing of the image in the main scan direction, the recording sheet is conveyed by one line in the sub-scan direction Y. The carriage is moved to the position where next printing starts, and printing of an image in the main scan direction starts. Likewise, an image is printed on the recording sheet by means of conveyance of the recording sheet and movement of the carriage in subsequent operations. Upon an entire image for one page is printed, the recording sheet printed with an image is discharged to the sheet discharge tray 21.

The scanner 12 is configured as a so-called flatbed scanner. An original cover 30 is provided as a top plate of the MFP 10, and a platen glass (not shown) is disposed beneath the original cover 30. An original is placed on the platen glass and read by means of the scanner 12 while being covered with the original cover 30. The operation panel 92 is for operating the printer 11 and the scanner 12, and operation keys 93 and an LCD 94 are provided on the panel.

Referring to FIG. 2A, an electrical configuration of the MFP 10 is described. As shown in FIG. 2, the MFP 10 includes a CPU 88, ROM 89, RAM 90, the operation keys 93, the LCD 94, the printer 11, and the scanner 12.

The CPU 88, the ROM 89, and the RAM 90 are connected with each other through a bus line 95. The operation keys 93, the LCD 94, the printer 11, the scanner 12, and the bus line 95 are connected to each other through an input/output port 96.

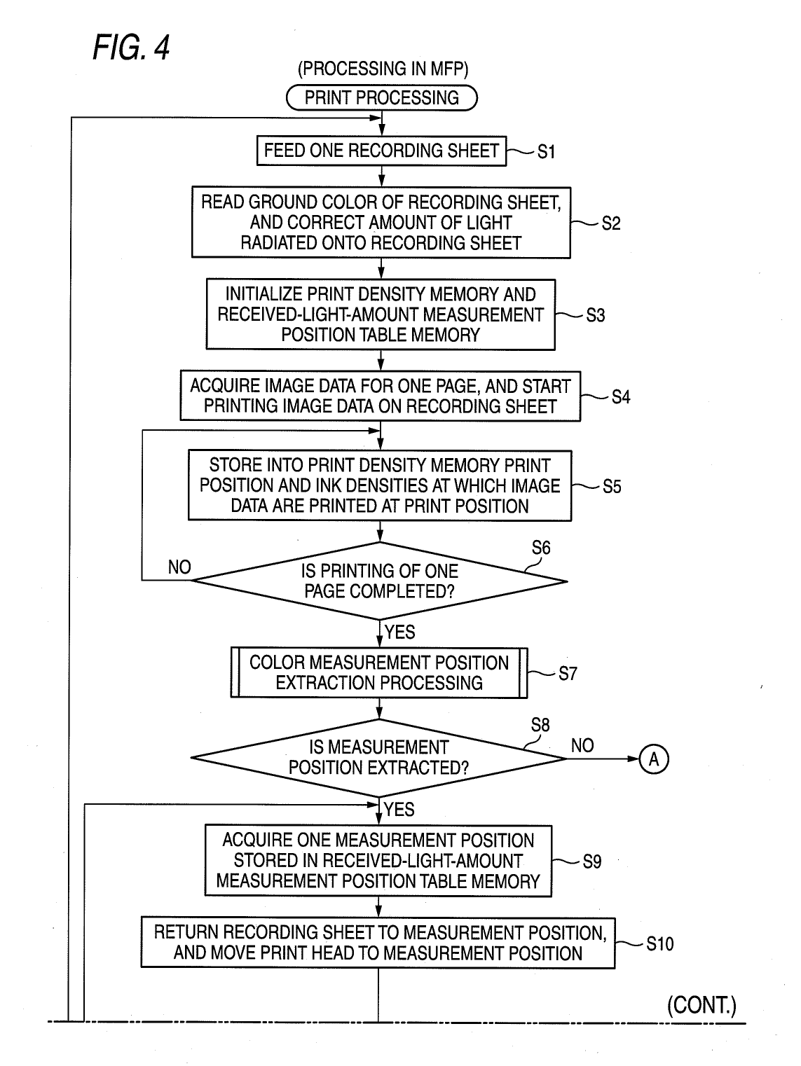

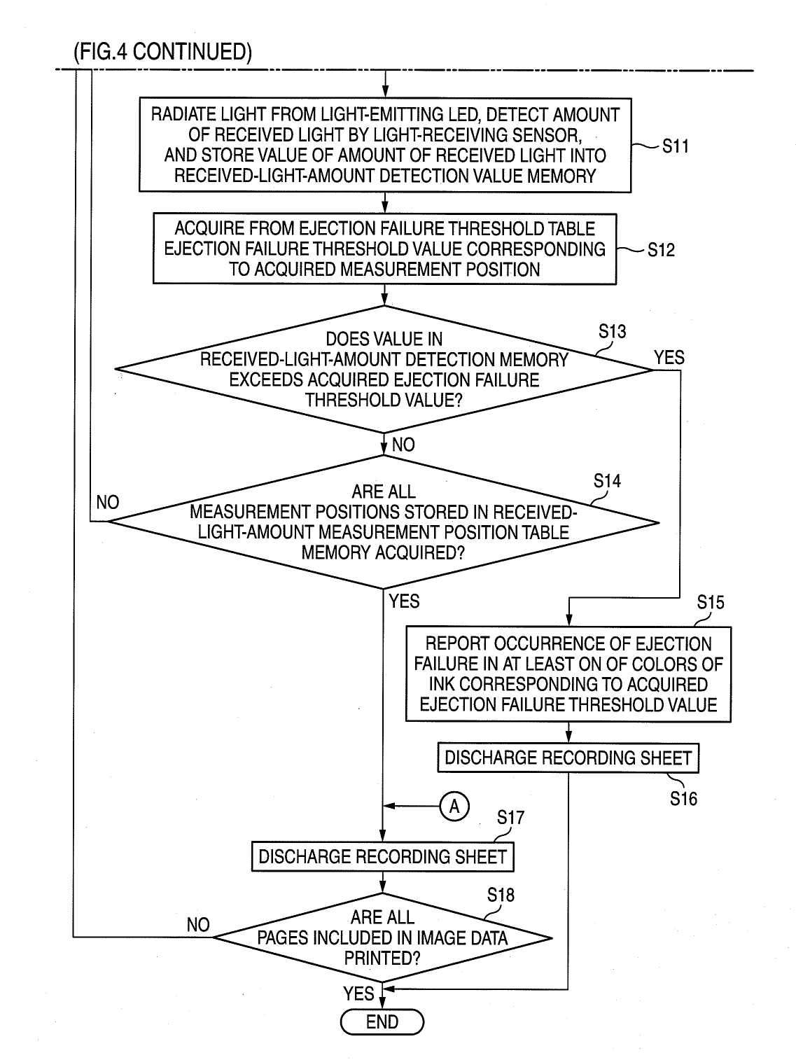

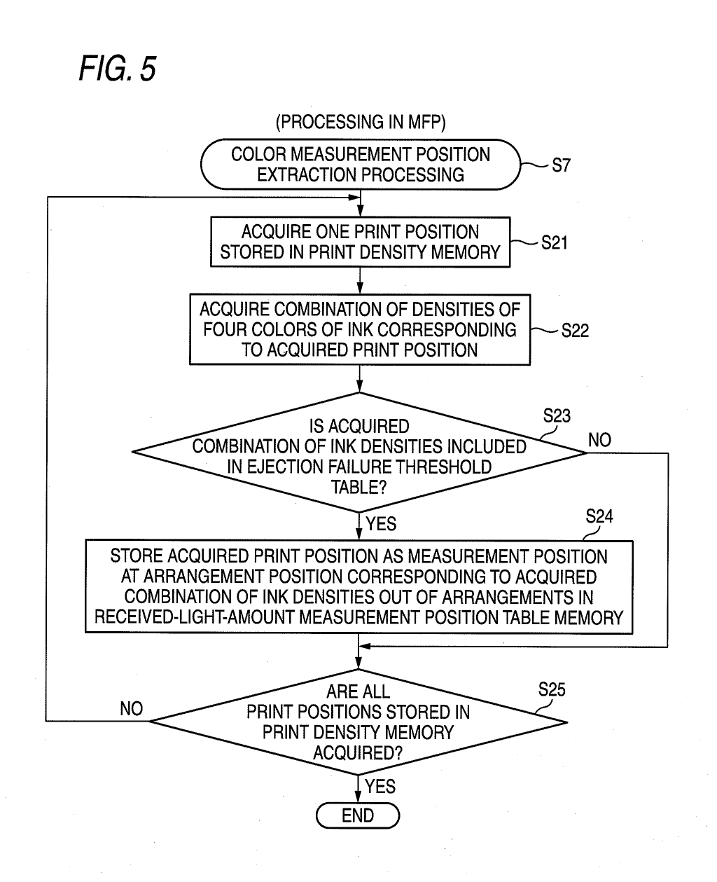

The CPU 88 is for controlling respective functions of the MFP 10 in accordance with predetermined values and programs stored in the ROM 89 and the RAM 90 and controlling respective sections connected to the I/O port 96. The ROM 89 is non-rewritable memory storing a control program to be executed by the MFP 10. Respective programs used for performing print processing shown in a flowchart of FIG. 4 and color measurement position extraction processing shown in a flowchart of FIG. 5 are stored in the ROM 89.

The ROM 89 includes an ejection failure threshold table memory 89a. The ejection failure threshold table memory 89a stores an ejection failure threshold table.

The ejection failure threshold table will be described by reference to FIG. 2B. The ejection failure threshold table includes combinations of densities of four colors (CMYK) of ink (reference ink density, reference recording material density) and ejection failure threshold values (thresholds) corresponding to the respective combinations. One ejection failure threshold value is associated with one of combinations of densities of four colors of ink. Table numbers “n” are sequentially assigned to the respective combinations of densities of four colors of ink.

The density of ink is a numeral corresponding to the amount of ink ejected from a print head 11a1; namely, the density of ink of an image to be printed on a recording sheet. The maximum value of ink density is 100, and the minimum value of ink density is 0. The larger the amount of ejected ink, the larger a numeral becomes. The smaller the amount of ejected ink, the smaller a numeral becomes. If the numeral is zero, ink is not ejected (no image is printed).

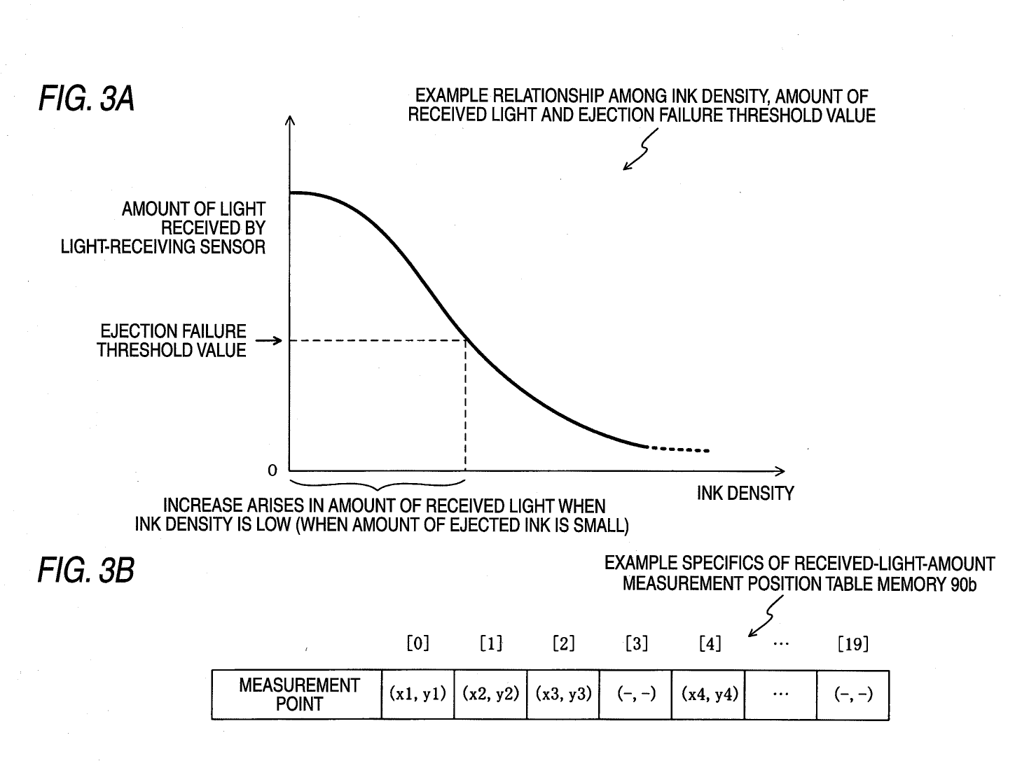

The ejection failure threshold value is a threshold used for determining whether ink is properly ejected from the print head 11a1, in print processing to be described later (see FIG. 4). Details will be described later by reference to FIG. 3A.

As shown in FIG. 2B, the ejection failure threshold table includes 20 types of combinations of densities of four colors of ink, and each of twenty types of combinations is associated with one ejection failure threshold value. The twenty types of combinations are sequentially assigned table numbers from [0] to [19] one by one. In order to plainly explain respective densities of four colors of ink in the following descriptions, the combination of densities of four colors of ink is described as an ink density level (a, b, c, d) wherein “a” represents the density of ink K, “b” represents the density of ink Y, “c” represents the density of ink C, and “d” represents the density of ink M.

As shown in FIG. 2B, table number [0] in the ejection failure threshold table is associated with an ink density level (100, 0, 0, 0) and an ejection failure threshold value of “20.” Table number [1] is associated with an ink density level (0, 100, 0, 0) and an ejection failure threshold value of “80.” The same also applies to the other combinations of ink densities, and therefore, their explanations will be omitted.

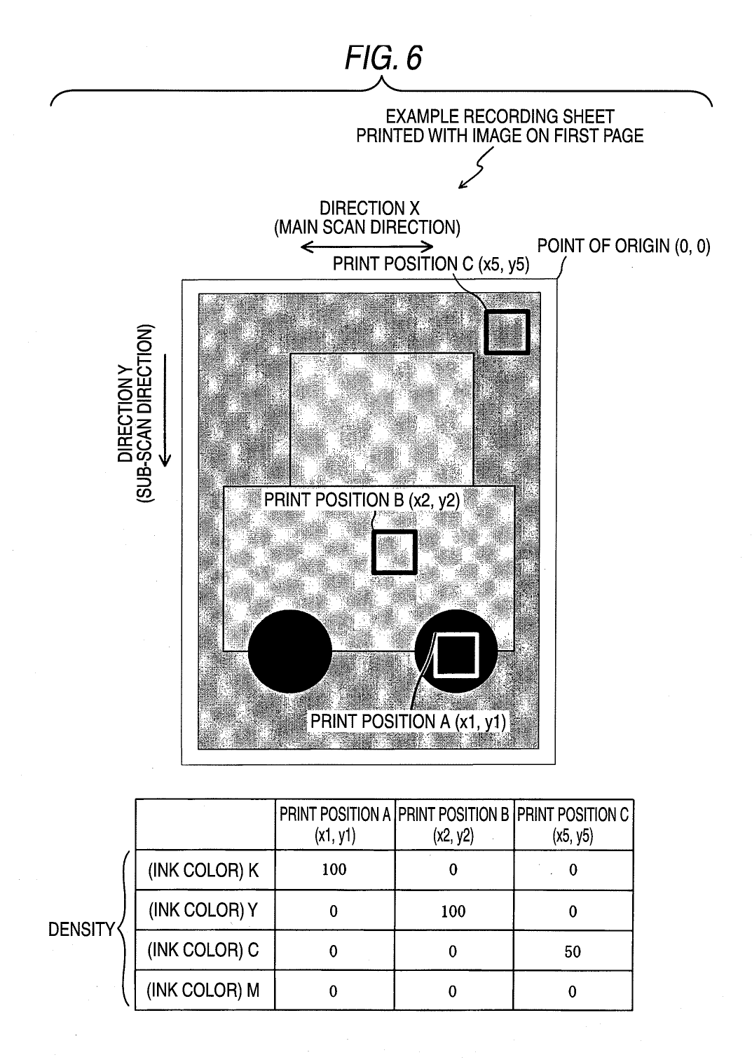

A relationship among the density of ink, the amount of received light, and an ejection failure threshold is now described by reference to FIG. 3A. In the present exemplary embodiment, when an image is printed on a recording sheet by means of combinations of densities of four colors (CMYK) of ink included in the ejection failure threshold table, a print position is stored in print density memory 90a to be described later. After the entire image for one page have been printed, light is emitted from the light-emission LED 11a2 to the image located at the stored print position, and the light-receiving sensor 11a3 detects the amount of light reflected from the image. As shown in FIG. 6, while an upper right corner of the recording sheet is taken as a point of origin (0, 0), a distance from the point of origin to an image along a main scan direction X is “x”, and a distance from the point of origin to an image along the sub-scan direction Y is taken as “y”, and the print position of the image is represented as a print position (x, y).

As the density of ink of the image printed on the recording sheet becomes greater, the light emitted from the light-emitting LED 11a2 is intensively absorbed by the image (ink) as shown in FIG. 3A. Therefore, the amount of light reflected from the image decreases, and the amount of received light detected by the light-receiving sensor 11a3 also decreases. In contrast, when the density of ink of the image becomes smaller, the light emitted from the light-emitting LED 11a2 becomes less likely to be absorbed by an image (ink). Therefore, the amount of light reflected from an image increases, so that the amount of received light detected by the light-receiving sensor 11a3 increases.

The ejection failure threshold is a value for determining whether the amount of received light detected by the light-receiving sensor 11a3 is a normal value. More specifically, the ejection failure threshold is the amount of received light when the light-emitting LED 11a2 emits light on the image printed at a normal ink density level and when the light-receiving sensor 11a3 detects the amount of reflected light.

In the present exemplary embodiment, after the entire image for one page have been printed on a recording sheet, the image printed on the recording sheet is irradiated with light, and the light-receiving sensor 11a3 detects the amount of reflected light (the amount of received light). If the amount of received light is equal to or less than the ejection failure threshold value, the density of ink is normal or high. Therefore, ink is determined to be ejected without occurrence of clogging. Meanwhile, if the amount of received light detected by the light-receiving sensor 11a3 exceeds an ejection failure threshold value, the density of ink is low, and therefore, it is determined that an ink ejection failure occurs.

The amount of ink ejected from each of ink ejection ports of the print head 11a1 is also thought to vary from one print head 11a1 to another. In consideration of variations, the ejection failure threshold may be set to a slightly-larger value.

Referring back to FIG. 2B, the RAM 90 is rewritable volatile memory and intended for temporarily storing various sets of data at the time of performance of each of operations of the MFP 10. The RAM 90 includes a print density memory 90a, a received-light-amount measurement position table memory 90b, and a received-light-amount detected value memory 90c.

The print density memory 90a stores, in a mutually-associated manner, all print positions where images have been printed on a recording sheet (ink has been ejected) and densities of four colors of ink of the image printed at the respective print positions (images that should have been printed). The ink density stored in the memory indicates a density of ink expected to be printed on a print position when printing is normally performed.

The received-light-amount measurement position table memory 90b stores a received-light-amount measurement position table. Detailed descriptions of the memory will be provided later (see FIG. 3). The received-light-amount measurement position table stores a measurement position (a print position) of an image among the image actually printed on a recording sheet, and the density of the image at the measurement position is measured.

The received-light-amount detection value memory 90c stores density of four colors of ink measured at the measurement position on a recording sheet stored in the received-light-amount measurement position table.

The received-light-amount measurement position table will now be described by reference to FIG. 3B. The received-light-amount measurement position table stores a measurement position (a print position) of an image of images actually printed on a recording sheet for measuring the density of four colors of ink. Specifically, a print position of an image, which is printed with a combination of densities of four colors of ink (CMYK) in the ejection failure threshold table (see FIG. 2B), in the image actually printed on a recording sheet is stored as a measurement position.

The received-light-amount measurement position table has arrangements corresponding to respective table numbers of the ejection failure threshold table. The print position of the image printed with the combination of densities of four colors of ink in the ejection failure threshold table is stored as a measurement position in association with the arrangement corresponding to the combination. The received-light-amount measurement position table has twenty arrangements respectively, sequentially assigned arrangement number [0] to arrangement number [19]. The arrangement number [n] of the received-light-amount measurement position table corresponds to the table number [n] of the ejection failure threshold table.

For example, the arrangement number [0] of the received-light-amount measurement position table corresponds to the table number [0] of the ejection failure threshold table. A print position (x1, y1) of an image printed with an ink density level (100, 0, 0, 0) of the table number [0] is stored as a measurement position. Further, an arrangement number [8] of the received-light-amount measurement position table corresponds to a table number [8] of the ejection failure threshold table, and a print position of an image printed with an ink density level (10, 10, 10, 10) of the table number [8] is stored as a measurement position. The same explanations apply to the other arrangements of the received-light-amount measurement position table, and therefore, their repeated explanations are omitted.

Print processing performed by the CPU 88 of the MFP 10 will now be described by reference to FIG. 4. This print processing is for measuring density of four colors of ink (CMYK) of an image corresponding to the ejection failure threshold table, of an image actually printed on a recording sheet when an entire image for one page is printed on the recording sheet and stopping printing operation when the measured density of ink exceeds a threshold value. This print processing is performed, for example, when a personal computer requests printing of image data. The image data may be any image data including a JPEG data, bitmap data or the like.

In this print processing, one recording sheet from a sheet-feeding tray 20 is fed at S1, and a ground color of the thus-fed recording sheet is read, and the amount of light emitted on the recording sheet is corrected at S2. Specifically, the light-emitting LED 11a3 emits light to the recording sheet, and the light-receiving sensor 11a2 detects the amount of reflected light and makes a correction to the amount of light to be emitted at operation S11 (described later) in accordance with the thus-detected amount of received light.

The amount of light emitted by the light-emitting LED 11a2 is usually set to the amount of light emitted onto an image printed on white plain paper. When the ground color of a recording sheet is other than white or when a recording sheet is glossy paper, the amount of reflected light is different from the amount of light reflected from white plain paper, and therefore, a correction has to be made to the amount of light to be emitted.

For example, when the ground color of a recording sheet is other than white, emitted light becomes more likely to be absorbed by the recording sheet as compared with the case of a white ground color, and therefore, the amount of reflected light decreases, and the amount of received light is also reduced. Therefore, the amount of light to be emitted is increased, so that the amount of light equal to that achieved in the case of white ground color can be received. Further, when the recording sheet is glossy paper, emitted light is reflected in greater amount when compared with the case of the recording sheet having white ground color, and therefore, the amount of received light is increased. Consequently, the amount of emitted light is reduced, thereby making it possible to receive the amount of light analogous to that achieved in the case of the recording sheet having white ground color.

By the operation S2, it is possible to detect occurrence of an ink ejection failure regardless of the type of a recording sheet, such as plain paper and glossy paper. Moreover, even when the ground color of the recording sheet is other than white, it is also possible to detect occurrence of an ink ejection failure.

The print density memory 90a and the received-light-amount measurement position table memory 90b of the RAM 90 are respectively initialized at S3, and an image for one page in the image data requested to be printed are acquired, and printing of an image on a recording sheet starts at S4. During the print head 11a1 prints an image on a recording sheet, the print position of an image and density of four colors of ink of an image (i.e., an image that should have been printed) printed at the print position are stored in the print density memory 90a while associated with each other at S5.

Next, at S6, it is determined whether printing of the entire image for one page has been completed. When printing of the image for one page has not yet been completed (No in S6), operation S5 is iterated. Meanwhile, when printing of the image for one page has been completed (Yes in S6), a color measurement position extraction processing is performed at S7.

Color measurement position extraction processing performed by the CPU 88 of the MFP 10 will now be described by reference to FIG. 5. Color measurement position extraction processing is for associating a combination of density of four colors of ink with a print position of an image, which is printed with a combination of densities of four colors of ink in the ejection failure threshold table, of the image for one page actually printed on a recording sheet, and extracting the print positions respectively as measurement positions.

In the color measurement position extraction processing, at S21, one print position is acquired among print positions of the image printed on a recording sheet, which are stored in the print density memory 90a. A combination of densities of four colors of ink stored in the print density memory 90a is acquired in association with the thus-acquired print position at S22.

Then, it is determined whether the combination of densities of four colors of ink acquired at S22 is included in the ejection failure threshold table of the ejection failure threshold table memory 89a at S23. If the thus-acquired combination of densities of four colors of ink is included (Yes in S23), the print position acquired at S21 is stored, as a measurement position, in association with the position of an arrangement corresponding to the combination of densities of four colors of ink acquired at S22 out of the arrangements of the received-light-amount measurement position table of the received-light-amount measurement position table memory 90b at S24.

If the acquired combination of densities of four colors of ink is not included in the ejection failure threshold table at S23 (No in S23), operation at S24 is skipped, thereby proceeding to S25.

At S25, it is determined whether all the print positions stored in the print density memory 90a are acquired (S25). If print positions, which have not yet been acquired, are still left (No in S25), processing returns to S21 and operations S21 to S25 are repeated. Meanwhile, if all of the print positions have been acquired (Yes in S25), color measurement position extraction processing is completed.

Referring back to the print processing shown in FIG. 4, if color measurement position extraction processing at S7 is completed, it is determined whether one or more measurement positions is extracted (S8). When the measurement position is not extracted at all (No in S8), operations S9 to S14 are skipped, thereby proceeding to S17. Meanwhile when one or more measurement positions are extracted (Yes in S8), one measurement position stored in the received-light-amount measurement position table in the received-light-amount measurement position table memory 90b is acquired at S9.

The recording sheet is returned, as a preparation for measurement of ink density, in the sub-scan direction Y to a position where the main scan direction X along which the carriage is movable crosses an image at a measurement position (inverts a conveyance direction), and the carriage is moved in the main scan direction X until the detection position of the light-receiving sensor 11a3 overlaps the measurement position at S10. The light-receiving sensor 11a3 mounted on the carriage is thereby set at a position where an image can be detected.

The light-emitting LED 11a2 emits a corrected amount of light, and the light-receiving sensor 11a3 detects the amount of light reflected form the image (an amount of received light). The thus-detected value is stored in the received-light-amount detection value memory 90c of the RAM 90 at S11.

An ejection failure threshold corresponding to the measurement position acquired at S9 is acquired from the ejection failure threshold table of the ejection failure threshold table memory 89a at S12. Specifically, if the arrangement number of the received-light-amount measurement position table, where the measurement position acquired through processing pertaining to S9 is stored, is [n], an ejection failure threshold value corresponding to the table number [n] of the ejection failure threshold table is acquired from the ejection failure threshold table. For example, when the measurement position acquired at S9 is stored in association with the arrangement number [1] of the received-light-amount measurement position table, an ejection failure threshold value “80” associated with the table number [1] of the ejection failure threshold table is acquired.

Next, it is determined whether the value stored in the received-light-amount detection value memory 90c exceeds the thus-acquired ejection failure threshold value at S13. In other words, at S13, it is determined whether the value stored in the received-light-amount detection memory 90c is within a range smaller than the acquired ejection failure threshold value. If it is determined that the value stored in the received-light-amount detection value memory 90c exceeds the thus-acquired ejection failure threshold value (Yes in S13), it is determined that an ink ejection failure has arisen due to clogging or ink empty or the like, and therefore, the LCD 94 and the like, reports (indicates) occurrence of an ink ejection failure in at least one of the four colors (CMYK) of ink corresponding to the acquired ejection failure threshold value (S15).

If the image printed at a measurement position is a monochrome and if any of ejection failure threshold values from table number [0] to table number [7] of the ejection failure threshold table is used at S13, the monochrome ink is determined to have ejection failure, so long as the detected amount of received light is in excess of the ejection failure threshold value. Therefore, specifically, occurrence of an ejection failure of monochrome ink can also be reported by means of the LCD 94 and the like.

After operation S15, the recording sheet on which ink ejection failure is detected is discharged to the sheet discharge tray 21, and print processing is completed. That is, printing of image data is stopped.

If the value stored in the received-light-amount detection value memory 90c is determined to be equal to the acquired ejection failure threshold value or less at S13 (No in S13), it may be the case where ink will be ejected at the measurement position without occurrence of clogging, whereby an image is normally printed. Therefore, processing subsequently proceeds to measurement of ink densities at another measurement point. Specifically, if the value stored in the received-light-amount detection value memory 90c is equal to or less than the acquired ejection failure threshold value (No in S13), at S14, it is determined whether all of the measurement positions stored in the received-light-amount measurement position table of the received-light-amount measurement position table memory 90b are acquired.

When a measurement position which has not been measured still remains in the received-light-amount measurement position table (No in S14), processing returns to S9, and operations S9 to S14 are repeated. Meanwhile, when all of the measurement positions stored in the received-light-amount measurement position table are acquired (Yes in S14), processing proceeds to S17.

At S17, a recording sheet having been printed an image for one page is discharged to the sheet discharge tray 21, and it is determined whether all pages included in the image data requested to be printed have been printed at S18.

When a page which has not been printed still remains in the image data requested to be printed (No in S18), processing returns to S1, and operations S1 to S18 are iterated. Meanwhile, when all pages of the image data requested to be printed have been printed (Yes in S18), print processing is completed.

According to the print processing shown in FIG. 4, every time an image for one page is printed on a recording sheet, a density of four colors (CMYK) of ink of an image corresponding to the ejection failure threshold table, of the image actually printed on the recording sheet is measured. If the measured ink density exceeds the threshold value, printing can be stopped.

Therefore, performance of printing in a state where ink ejection failure has occurred can be prevented or reduced, whereby occurrence of a fault in the printer 11 can be prevented or reduced. Moreover, it is determined whether an ink ejection failure has occurred, in accordance with an image actually printed on the recording sheet. Therefore, an ink ejection failure can be detected without printing a detection mark, such as a registration mark or a trim mark. Accordingly, consumption of ink can be reduced when compared with a case where the registration mark or a trim mark is separately printed.

Since an ink ejection failure can be detected without printing a detection mark, such as a registration mark or a trim mark, the present invention is particularly effective for a case where borderless printing through which a registration mark or a trim mark cannot be printed is performed.

The carriage usually includes a light emitting LED and a light-receiving sensor for detecting the position of the recording medium. According to the above-described printer, since a density of an image is detected by returning the sheet after an image for one page is printed, the light emitting LED and the light-receiving sensor for detecting the position of the recording medium can also be used for detecting the density of the image printed on the recording medium.

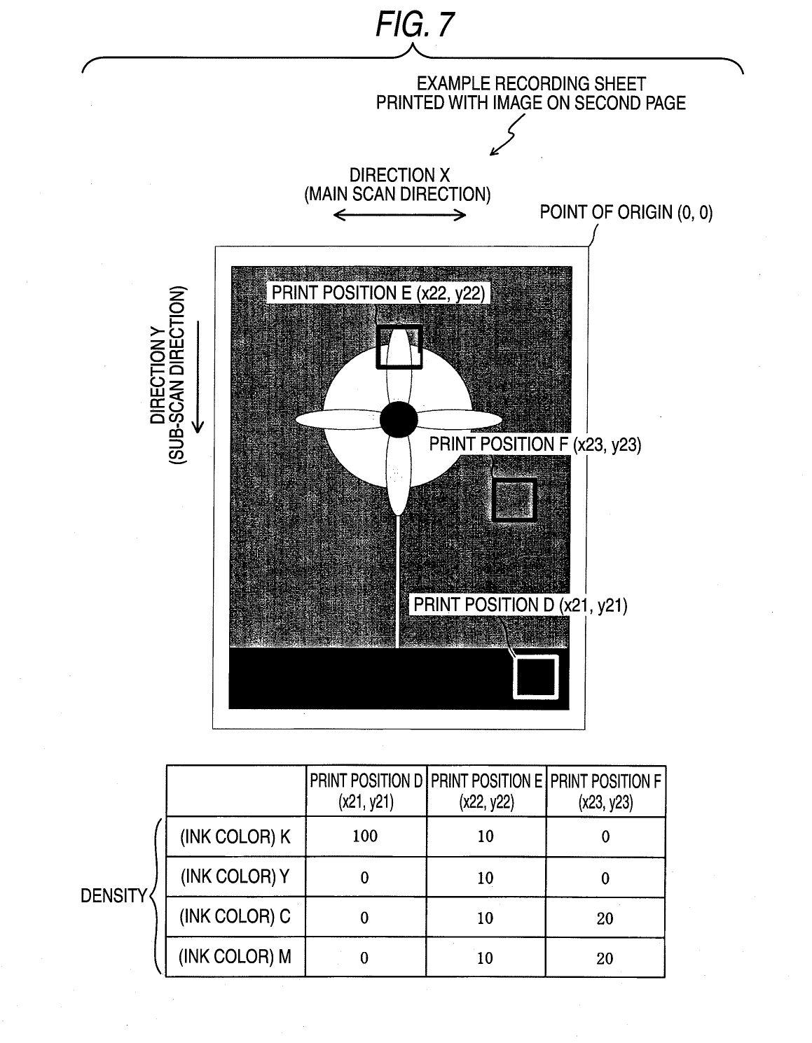

By reference to FIGS. 6 and 7, an example case where print processing is performed will now be described. The direction X in FIGS. 6 and 7 represents a direction in which a carriage moves, that is, a direction in which an image is printed (a main scan direction). The direction Y in FIGS. 6 and 7 represents a direction in which a recording sheet is fed after printing of one line (a sub-scan direction).

As mentioned above, for example, when a personal computer requests printing of image data, print processing is performed. In the following, image data are assumed to include two pages of images. As shown in FIG. 6, on the first page of recording sheet, an image is printed with an ink density level (100, 0, 0, 0) at a print position A (x1, y1), an image is printed with an ink density level (0, 100, 0, 0) at a print position B (x2, y2), and an image is printed with an ink density level (0, 0, 50, 0) at a print position C (x5, y5).

As shown in FIG. 7, on the second page of recording sheet, an image is printed with an ink density level (100, 0, 0, 0) at a print position D (x21, y21) of the recording sheet, an image is printed with an ink density level (10, 10, 10, 10) at a print position E (x22, y22) of the same, and an image is printed with an ink density level (0, 0, 20, 20) at a print position F (x23, y23) of the same.

First, the image shown in FIG. 6 is assumed to have been printed on the first page of the recording sheet. As mentioned above, during the course of the image on the first page being recorded on a recording sheet, a print position of each image and densities of four colors of ink of the image expected to be printed at that print position are associated with each other and stored in the print density memory 90a every time the print head 11a1 prints an image.

That is, after the image on the first page has been printed on the recording sheet, the print position A (x1, y1) and the ink density level (100, 0, 0, 0) are associated with each other and stored in the print density memory 90a. Likewise, other print positions and ink density levels of the respective print positions are stored.

Combinations of ink density levels in the ejection failure threshold table of the ejection failure threshold table memory 89a are extracted from the combinations of densities of four colors of ink stored in the print density memory 90a. Print positions stored in the print density memory 90a while associated with the thus-extracted combinations of ink density levels are stored as measurement positions in the received-light-amount measurement position table of the received-light-amount measurement position table 90b.

In the print density memory 90a, for example, an ink density level (100, 0, 0, 0), an ink density level (0, 100, 0, 0), and an ink density level (0, 0, 50, 0) respectively correspond to ink density levels in the ejection failure threshold table. Therefore, a print position A (x1, y1), a print position B (x2, y2), and a print position C (x5, y5) corresponding to the respective densities of four colors of ink are stored, as measurement points, in the received-light-amount measurement position table.

If a combination of densities of four colors of ink is stored in the ejection failure threshold table and if a table number stored in association with the combination is [n], a print position corresponding to the combination is stored as a measurement position in association with an arrangement number [n] of the received-light-amount measurement position table. For example, since the ink density level (100, 0, 0, 0) is stored in association with the table number [0] of the ejection failure threshold table, the print position A (x1, y1) corresponding to the ink density level (100, 0, 0, 0) is stored, as a measurement position, in association with an arrangement number [0] for the received-light-amount measurement position table.

When all measurement positions for one page are thus stored in the received-light-amount measurement position table, the received-light sensor 11a3 detects the amount of light received at a measurement position one after another. Detected values (amounts of received light) are compared with ejection failure threshold values corresponding to the measurement positions, respectively.

For example, it is assumed that, on the first page of the recording sheet, the amount of received light is detected at a measurement position, i.e., a print position A (x1, y1) of the arrangement number [0] in the received-light-amount measurement position table. Then, the amount of received light “15” would be detected. An ejection failure threshold value corresponding to the arrangement number [n] of the received-light-amount measurement position table is an ejection failure threshold value for the table number [n] of the ejection failure threshold table. Therefore, an ejection failure threshold value for the arrangement number [0] is “20.”

The amount of received light “15” detected at the measurement position, which is a print position A (x1, y1), is smaller than the ejection failure threshold value “20”, and therefore, the density of ink is determined to be normal or high. Therefore, ink has been ejected without occurrence of clogging. Then, the amount of light received at the next measurement position is detected, and the thus-detected amount of received light is compared with an ejection failure threshold value corresponding to the measurement position. Specifically, the amount of received light detected at the print position B (x2, y2) is compared with an ejection failure threshold value “80” (see table number [1]). The amount of received light detected at the print position C (x5, y5) is compared with an ejection failure threshold value “15” (see table number [6]).

Amounts of light received at all of the measurement positions in the received-light-amount measurement position table are detected, and if the respective amounts of received light are equal to or less than ejection failure threshold values, respectively, a recording sheet on the first page is discharged to the sheet discharge tray 21. Then, an image shown in FIG. 7 is printed on a recording sheet on the second page. Meanwhile, if the amount of received light detected at any of the measurement positions exceeds a corresponding ejection failure threshold value, the density of ink is low, and an ink ejection failure is determined to have arisen. Occurrence of an ink ejection failure is reported, and only the recording sheet on the first page is printed, and printing operation is stopped. In the present exemplary embodiment, when the ink ejection failure has arisen as mentioned above, printing of remaining pages is stopped. Accordingly, undesired consumption of ink and undesired consumption of a recording sheet can be prevented or reduced.

In the ejection failure threshold table of the present exemplary embodiment, twenty types of combinations of densities of four colors of ink are prepared. There are provided combinations of densities of monochrome ink (see table numbers [0] to [7]) and combinations of densities of mixed colors of ink that is a mixture of two colors or more (see table numbers [8], [9] and [19]).

Therefore, even when an image to be printed on a recording sheet is in monochrome or in a mixed color, occurrence of an ink ejection failure can be detected. So long as the number of types of combinations of densities of four colors of ink in the ejection failure threshold table is increased, occurrence of an ink ejection failure can be detected from a larger number of types of images. Therefore, the accuracy of detection of ink ejection failure can be enhanced.

The ejection failure threshold table of the present exemplary embodiment is provided with a plurality of types of combinations of densities of monochrome ink. For example, the ink is black, an ink density level (100, 0, 0, 0) (see table number [0]) and an ink density level (50, 0, 0, 0) (see table number [4]) are provided. Therefore, occurrence of ink ejection failure can be detected from a larger number of types of images, and therefore, the accuracy of detection of ink ejection failure can be enhanced.

For a recording sheet on the second page, a print position D (x21, y21), a print position E (x22, y22), and a print position F (x23, y23) are first stored as measurement positions in the received-light-amount measurement position table as in the case of the recording sheet on the first page.

Subsequently, a comparison between the amount of received light detected at the print position D (x21, y21) and an ejection failure threshold value “20” (see table number [0]), a comparison between the amount of received light at the print position E (x22, y22) and an ejection failure threshold value “25” (see table number [8]), and a comparison between the amount of received light detected at the print position F (x23, y23) and an ejection failure threshold value “20” (see table number [9]) are respectively performed.

If the amounts of received light detected at the respective measurement positions are the ejection failure threshold value or less, the recording sheet on the second page is discharged to the sheet discharge tray 21, and printing is completed. Meanwhile, if the amount of received light detected at any of the measurement positions exceeds the ejection failure threshold value, ink ejection failure is determined to have occurred, and therefore, occurrence of ink ejection failure is reported, and printing is stopped.

While the present invention has been shown and described with reference to certain exemplary embodiments thereof, it will be understood by those skilled in the art that various changes in form and details may be made therein without departing from the spirit and scope of the invention as defined by the appended claims.

For example, in the above-described exemplary embodiment, an image is printed on a recording sheet in four colors of ink. However, even when one color of ink is used or when four colors or more of ink are used, the present invention is applicable.

In the above-described exemplary embodiment, an image is printed on a recording sheet by means of the inkjet printer 11. However, the present invention can also be applied to a laser printer, a heat transfer printer, and a sublimation printer.

In the above-described exemplary embodiment, the received light amount by the light-receiving sensor 11a3 is compared with an ejection failure threshold value for determining occurrence of an ejection failure. And, if it is determined that the received light amount exceeds the ejection failure threshold value, it is determined that ejection failure occurs. However, the printer may be configured such that if it is determined that the received light amount is smaller than the ejection failure threshold value, it is determined that ejection failure occurs. In this case, ejection failure in which print head 11a1 ejects ink more than normal can be detected. Alternatively, the received light amount may be compared with a range determined based on the ejection failure threshold value. In this case, if it is determined that the received light amount is outside the range, it is determined that ejection failure occurs. Further, in this case, a value range may be stored in the ejection failure threshold table as a ejection failure threshold value.

In the above-described exemplary embodiment, every time the print head 11a1 prints an image, the print position of the image and densities of four colors of ink of the image printed at the print position (an image that should have been printed) are associated with each other and stored in the print density memory 90a. However, the printer can also be configured such that, based on image data, the print position of each image and densities of four colors of ink of the image printed at the print position (the image that should have been printed) can be associated with each other and stored in the print density memory 90a.

In the above-described exemplary embodiment, the amount of received light is measured after an entire image for one page have been printed on a recording sheet, and it is determined whether ink ejection failure has arisen. However, occurrence of an ink ejection failure can also be determined by detecting the amount of received light while printing is being performed before the printing is completed. So long as the printer is configured as mentioned above, a time consumed for detecting the amount of received light after an image for one page has been printed on a recording sheet can be shortened. Hence, a time period from the time when printing starts to the time when printing is completed can be shorted. For example, the light-receiving sensor 11a3, the light-emitting LED 11a2, and the print head 11a1 may be arranged in the carriage toward a direction in which an image is printed (the direction X in FIG. 6), in this order. Alternatively, the light-receiving sensor 11a3, the light-emitting LED 11a2, and the print head 11a1 may be arranged in the carriage toward a direction in which a recording sheet is conveyed (the direction Y in FIG. 6). According to these arrangements, after printing of an image, the amount of receiving light on the printed image can be detected, subsequently.

During color measurement position extraction processing of the above-described exemplary embodiment, density of four colors of ink of an image, which corresponds to an ejection failure threshold table, of the images actually printed on a recording sheet are extracted. However, if there is not any image corresponding to the ejection failure threshold table, the printer can also be configured so as to extract densities of ink of an image printed with ink densities closest to the combination of densities of four colors of ink in the ejection failure threshold table. So long as the printer is thus configured, at least one measurement point or more can be extracted from each recording sheet. Therefore, it is possible to enhance the accuracy of detection of an ink ejection failure and the possibility of detection of an ink ejection failure.

Although ejection failure threshold values corresponding to densities of four colors of ink are stored in the ejection failure threshold table in the above-described embodiment, the printer can also be configured so as to store a calculating formula for calculating an ejection failure threshold value from densities of four colors of ink without storing an ejection failure threshold value. For example, when an ejection failure threshold table is provided, a larger area for storing an ejection failure threshold value has to be ensured with an increase in the number of types of densities of four colors of ink. However, so long as the printer is configured so as to store a calculating formula for calculating an ejection failure threshold value, it is necessary to assure only an area for storing a calculating formula. Therefore, consumption of a storage area can be reduced.

What is claimed is:

1. A printer comprising:
a print unit which prints an image on a recording medium by adhering recording material thereonto based on image data;
a storage unit which stores a value corresponding to a reference recording material density;
a reference density acquisition unit which acquires from the image data a reference recording material density of an area within the image;
a specifying unit which specifies a value corresponding to the reference recording material density acquired by the reference density acquisition unit by referring to the storage unit;
a detection unit which detects a recording material density in the area of the image printed on the recording medium by the print unit;
a determination unit which determines whether the recording material density in the area detected by the detection unit is within a range determined based on the value specified by the specifying unit; and
a controller which indicates a print failure and/or stops printing if the determination unit determines that the recording material density detected by the detection unit is outside of the range.

2. The printer according to claim 1,
wherein the reference density acquisition unit extracts from the image data an area in which the print unit prints an image with a reference recording material density corresponding to a value stored in the storage unit, and acquires a reference recording material density of the area extracted from the image data.

3. The printer according to claim 1,
wherein the storage unit stores a plurality of values corresponding to a plurality reference recording material densities, respectively, and
wherein the reference density acquisition unit acquires at least one reference recording material density from the plurality of reference recording material densities.

4. The printer according to claim 3,
wherein at least one of the reference recording material densities is defined by densities of a plurality of colors of recording material, and
wherein if acquiring a reference recording material density defined by densities of a plurality of colors of recording material, the reference density acquisition unit acquires a reference recording material density which matches the densities of the plurality of colors, respectively.

5. The printer according to claim 1,
wherein the detection unit is configured to emit light to the area of the image printed on the recording medium and detect an amount of reflection light as the recording material density in the area, and
wherein the detection unit comprises a correction unit which corrects an amount of the emitted light according to a type of the recording medium.

6. The printer according to claim 1,
wherein the determination unit determines whether the recording material density in the area detected by the detection unit is smaller than the value specified by the specifying unit, and
wherein the controller indicates a print failure and/or stops printing if the determination unit determines that the recording material density is smaller than the value.

7. The printer according to claim 1,
wherein the print unit ejects an ink on a recording medium as the recording material to print an image.

8. The printer according to claim 7,
wherein the print unit includes a carriage which is movable in a first direction and a conveying unit which conveys the recording medium in a second direction orthogonal to the first direction, the carriage including an inkjet head which ejects an ink while reciprocally moving in the first direction to form an image on the recording medium, and
wherein the detection unit is provided on the carriage and includes a light emitting unit which emits light on the recording medium and a light receiving unit which receives a reflected light to detect the recording material density.

9. The printer according to claim 8,
wherein the detection unit detects the density in the area of the image printed on the recording medium after the print unit finishes printing of an image for one page of a recording medium.

10. The printer according to claim 8,
wherein the detection unit detects the density in the area of the image printed on the recording medium during the printing of the image.

11. The printer according to claim 1,
wherein the printer performs a borderless printing.

12. A print method for a printer including a print unit which prints an image of a recording medium by adhering recording material thereonto based on image data, and a storage unit which stores values corresponding to a plurality of reference recording material densities, the print method comprising:
extracting an area in which an image is printed by the print unit with any one of the plurality of reference recording material densities, from the image data, and acquiring a reference recording material density of the extracted area;
specifying a value corresponding to the acquired reference recording material density by referring to the storage unit;
detecting a recording material density in the area of the image printed on the recording medium;
determining whether the detected recording material density in the area is within a range based on the specified value; and
indicating a print failure and/or stopping printing if it is determined that the detected recording material density is outside of the range.
